(19) United States
(12) Patent Application Publication
(10) Pub. No.: US 2025/0391391 A1
(43) Pub. Date: Dec. 25, 2025

(54) AUDIO PROCESSING METHOD AND DEVICE

(71) Applicant: Harman International Industries, Incorporated, Stamford, CT (US)

(72) Inventors: Hongfei Zhou, Shenzhen (CN); Teng Liu, Shenzhen (CN)

(73) Assignee: Harman International Industries, Incorporated, Stamford, CT (US)

(21) Appl. No.: 19/242,291

(22) Filed: Jun. 18, 2025

(30) Foreign Application Priority Data
Jun. 24, 2024 (CN) 2024108166738

(51) Int. Cl. G10H 1/00; G10H 1/46

(52) U.S. Cl. CPC G10H 1/0091; G10H 1/46; G10H 2210/311

(57) ABSTRACT

A audio processing method for generating an amplified audio signal carried out by receiving a first audio signal, the first audio signal being an electric musical instrument signal collected from an electric musical instrument, performing first processing on the first audio signal to generate a first processed audio signal, the first processing including at least linear distortion processing and nonlinear distortion processing, amplifying the first processed audio signal to generate a first amplified audio signal, and outputting the first amplified audio signal to a music speaker.

### CROSS REFERENCE

Priority is claimed to application No. 202410816673.8, filed Jun. 24, 2024, in China, the disclosure of which is incorporated in its entirety by reference.

### TECHNICAL FIELD

The present disclosure relates to the field of audio processing, and more particularly to an audio processing method and an audio processing device.

### BACKGROUND

Electric musical instruments are the product of the development of modern electronic technology. Widely used electric musical instruments include, for example, electric guitars, electric basses, electric pianos, and the like. Taking an electric guitar as an example, its sound-producing principle is different from that of a traditional guitar. Instead of producing sound through the vibration of the box, it produces sound by using the principle of electromagnetism. The body of the electric guitar is made of solid wood rather than a hollow box. The body is equipped with a pickup that is usually made of a coil. When the guitar strings vibrate and cause the magnetic flux of the pickup coil to change, an electric current is generated in the coil. This electric current is restored through an electronic device to produce the sound of the electric guitar. Therefore, electric musical instruments such as electric guitars usually need to be used in conjunction with amplifiers, speakers, etc. For example, an electric guitar needs to be connected to a guitar amplifier (or referred to as a guitar sound box) when playing.

Due to the inherent characteristics of a vacuum tube circuit, the sound produced by early guitar amplifiers is often distorted. For example, the low-power speakers used in early guitar amplifiers will produce a cracked sound when the volume is high, resulting in speaker distortion. However, this speaker distortion results in a unique guitar timbre (e.g., rough and broken timbre and compression). Due to auditory habits or subjective psychological factors, musicians and listeners seem to prefer such a guitar timbre with unique distortion effects. This also means that although the technology of guitar amplifiers has developed from vacuum tube amplifiers to digital amplifiers, people are still committed to reproducing the unique distortion effects of early guitar amplifiers. Therefore, the sound produced by existing guitar amplifiers is usually inherently accompanied by distortion, which makes the guitar amplifiers unsuitable for amplifying music signals other than electric guitar signals, thereby greatly limiting the usage scenarios of the guitar amplifiers.

### SUMMARY OF THE INVENTION

In view of the above problems, the present disclosure provides an audio processing method and device capable of amplifying both electric musical instrument signals such as electric guitar signals and music signals.

According to at least one aspect of the present disclosure, an audio processing method is provided, including: receiving a first audio signal, the first audio signal being an electric musical instrument signal collected from an electric musical instrument; performing first processing on the first audio signal to generate a first processed audio signal, the first processing including at least linear distortion processing and nonlinear distortion processing; amplifying the first processed audio signal to generate a first amplified audio signal; and outputting the first amplified audio signal to a music speaker.

In one or more embodiments of the present disclosure, the linear distortion processing includes changing an amplitude or phase of a frequency component of the first audio signal to generate a linear distortion result, and the nonlinear distortion processing includes adding a new frequency component to the first audio signal to generate a nonlinear distortion result, where performing the first processing on the first audio signal to generate the first processed audio signal includes: generating the first processed audio signal based at least on the linear distortion result, the nonlinear distortion result, and the first audio signal.

In one or more embodiments of the present disclosure, generating the first processed audio signal based at least on the linear distortion result, the nonlinear distortion result, and the first audio signal includes: weighting the linear distortion result, the nonlinear distortion result, and the first audio signal to generate a weighted signal, and generating the first processed audio signal based on the weighted signal.

In one or more embodiments of the present disclosure, the first processing further includes first equalization processing that includes filtering and gain adjustment of the weighted signal to enable the first processed audio signal to be within a predetermined frequency range and have a predetermined frequency response curve.

In one or more embodiments of the present disclosure, the first processing further includes effect processing that changes one or more of waveform, wavelength, phase, amplitude, and frequency component of the first audio signal.

In one or more embodiments of the present disclosure, the audio processing method further includes: receiving a second audio signal, the second audio signal being a music signal; performing second processing on the second audio signal to generate a second processed audio signal; amplifying the second processed audio signal to generate a second amplified audio signal; and outputting the second amplified audio signal to the music speaker.

In one or more embodiments of the present disclosure, the audio processing method further includes: receiving a second audio signal, the second audio signal being a music signal; performing second processing on the second audio signal to generate a second processed audio signal; combining the first processed audio signal and the second processed audio signal to generate a combined signal, and amplifying the combined signal to generate a third amplified audio signal; and outputting the third amplified audio signal to the music speaker.

In one or more embodiments of the present disclosure, the electric musical instrument is an electric guitar or an electric bass, and the music speaker is a full-frequency speaker covering a frequency range perceivable by a human ear.

According to at least one aspect of the present disclosure, an audio processing method is provided, including: receiving a first audio signal and a second audio signal, the first audio signal being an audio signal collected from an electric musical instrument, and the second audio signal being a music signal; performing first processing on the first audio signal to generate a first processed audio signal, and performing second processing on the second audio signal to generate a second processed audio signal, where the first processing includes at least linear distortion processing and nonlinear distortion processing; receiving a selection of an audio amplification mode from a plurality of audio amplification modes; in the selected audio amplification mode, amplifying at least one of the first processed audio signal and the second processed audio signal to generate an amplified audio signal; and outputting the amplified audio signal to a music speaker.

According to at least one aspect of the present disclosure, an audio processing device is provided, including: a first audio interface configured to receive a first audio signal, the first audio signal being an electric musical instrument signal collected from an electric musical instrument; a memory having computer-readable instructions store therein; at least one processor configured to execute the computer-readable instructions to: perform first processing on the first audio signal to generate a first processed audio signal, the first processing including at least linear distortion processing and nonlinear distortion processing; and amplify the first processed audio signal to generate a first amplified audio signal; and a music speaker configured to output the first amplified audio signal.

In one or more embodiments of the present disclosure, the audio processing device further includes a second audio interface configured to receive a second audio signal, the second audio signal being a music signal, where the at least one processor is further configured to: perform second processing on the second audio signal to generate a second processed audio signal; and amplify the second processed audio signal to generate a second amplified audio signal; and the music speaker is further configured to output the second amplified audio signal.

In one or more embodiments of the present disclosure, the audio processing device further includes a second audio interface configured to receive a second audio signal, the second audio signal being a music signal; perform second processing on the second audio signal to generate a second processed audio signal; combine the first processed audio signal and the second processed audio signal to generate a combined signal, and amplify the combined signal to generate a third amplified audio signal; and output the third amplified audio signal to the music speaker.

According to another aspect of the embodiments of the present disclosure, a computer-readable storage medium is provided, having computer-readable instructions stored thereon, the computer-readable instructions, when executed by a processor, cause the processor to perform the method as described in any one of the above aspects of the present disclosure.

According to another aspect of the embodiments of the present disclosure, a computer program product is provided, including computer-readable instructions therein, the computer-readable instructions, when executed by a processor, cause the processor to perform the method as described in any one of the above aspects of the present disclosure.

By utilizing the audio processing method and the audio processing device according to the above aspects of the present disclosure, it is possible to use a conventional music speaker to produce a guitar sound with a unique distortion effect without the need for a guitar speaker with a narrow frequency range and including a linear or nonlinear distortion component, and it is possible to simultaneously provide a plurality of audio amplification modes including a musical instrument amplification mode, a music amplification mode, a hybrid amplification mode, etc., in the same audio processing device (e.g., a guitar amplifier), thereby overcoming the technical defects in the prior art that guitar amplifiers cannot amplify music signals and that conventional music amplifiers cannot satisfactorily amplify electric guitar signals, and realizing a plurality of audio processing functions that can amplify both electric musical instrument signals such as electric guitar signals and music signals, and can add accompaniment music to the musical instrument sound when playing electric musical instruments, thereby greatly improving the user experience and reducing the complexity of audio processing.

### DESCRIPTION OF THE DRAWINGS

The above and other objects, features and advantages of the embodiments of the present disclosure will become more apparent through a more detailed description of the embodiments of the present disclosure in conjunction with the accompanying drawings. The accompanying drawings are used to provide further understanding of the embodiments of the present disclosure and constitute a part of the specification. They are used to explain the present disclosure together with the embodiments of the present disclosure and do not constitute a limitation of the present disclosure. In the accompanying drawings, like reference numerals generally represent like components or steps.

FIG. 1 illustrates a flowchart of an audio processing method according to one or more embodiments of the present disclosure;

FIG. 2 illustrates a flowchart of an audio processing method according to an example of one or more embodiments of the present disclosure;

FIG. 3 illustrates another flowchart of an audio processing method according to one or more embodiments of the present disclosure;

FIG. 4 illustrates yet another flowchart of an audio processing method according to one or more embodiments of the present disclosure;

FIG. 5 illustrates a flowchart of an audio processing method according to another example of one or more embodiments of the present disclosure;

FIG. 6 illustrates another flowchart of an audio processing method according to one or more embodiments of the present disclosure; and

FIG. 7 illustrates a schematic structural view of an audio processing device according to one or more embodiments of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only some of the embodiments of the present disclosure, rather than all the embodiments. Based on the embodiments of the present disclosure, all other embodiments obtained by those of ordinary skill in the art without making creative effort shall fall within the scope of protection of the present disclosure.

As illustrated in the embodiments and the claims of the present disclosure, unless otherwise indicated clearly in the context, the words “a,” “an,” “a kind of,” and/or “the”, and the like do not refer specifically to the singular, but may also include the plural. The words “first,” “second,” and the like used in the present disclosure do not indicate any order, quantity or importance, but are only used to distinguish different components. Similarly, the words “including,” “comprising,” and the like mean that the element or object preceding the words includes the elements or objects listed after the words and equivalents thereof, but do not exclude other elements or objects. The words “connected,” “coupled,” and the like are not limited to physical or mechanical connections, but may include electrical connections, whether direct or indirect.

In the embodiments of the present application, the term “module” or “unit” refers to a computer program or a segment of a computer program that has a predetermined function and works together with other related parts to achieve a predetermined goal, and can be implemented entirely or in part by using software, hardware (such as a processing circuit or memory) or a combination thereof. Likewise, one processor (or a plurality of processors or memories) can be used to implement one or more modules or units. Furthermore, each module or unit may be a part of an integral module or unit that includes the function of the module or unit.

Furthermore, flowcharts are used in the present disclosure to illustrate operations performed by a system according to embodiments of the present disclosure. It should be understood that the preceding or following operations are not necessarily performed precisely in sequence. Instead, various steps may be processed in a reverse order or concurrently. Meanwhile, it is also possible to add other operations to these processes or to remove a step or steps from these processes.

In the embodiments of the present disclosure, an electric musical instrument refers to a musical instrument that uses electronic technology to produce sound, such as an electric guitar, electric bass, etc., but the embodiments of the present disclosure do not impose specific limitation in this regard, and it may also refer to any electric musical instrument that is suitable for the audio processing method of the present disclosure. In the following, for the sake of convenience, the audio processing method of the present disclosure is generally described by taking an electric guitar and a guitar amplifier as an example, but this is only an example and does not constitute limitation of the present disclosure in any sense.

A guitar amplifier is usually composed of an effects unit, an amplifier, and a guitar speaker. The effects unit can add electronic sound effects such as distortion, echo, reverberation, chorus, vibrato, etc. to the audio signal, the amplifier amplifies the audio signal, and the guitar speaker converts the amplified audio signal into sound and outputs it. Generally speaking, conventional music speakers strive to recreate sound as accurately as possible, so ideally they are expected to have a linear frequency response curve over the full frequency range audible to the human ear (approximately 20 Hz to 20 kHz). Unlike conventional music speakers, guitar speakers usually only cover a narrow frequency range where guitar sound is situated (e.g., approximately 60 Hz to 5 kHz) but have a greater sound pressure level (SPL), and in order to reproduce the distortion effects of early speakers, guitar speakers usually include linear distortion and/or nonlinear distortion processing components to produce a guitar timbre with unique distortion effects.

As mentioned above, the speakers used in early guitar amplifiers often had distortion. Such speaker distortion was caused by the characteristics of the guitar speakers themselves, such as their lighter weight and softer rubber edges compared to conventional speakers. The nonlinear vibration of the guitar speakers causes the guitar sound produced to contain additional harmonics in addition to the fundamental wave. The superposition of the fundamental wave and the harmonics produces harmonic distortion, resulting in the unique timbre of the guitar speakers. Although the effects unit in the guitar speakers can also add some distortion effects to the audio signal, such distortion is reprocessing of the input audio signal. For example, “clipping” processing is to excite the input audio signal beyond the tolerance range of the audio device. That is to say, unlike the distortion simulated by the effects unit, the causes of guitar speaker distortion are more complicated.

The above characteristics of guitar speakers make it impossible for guitar amplifiers to be used for amplifying conventional music signals other than electric guitar signals. On the one hand, the guitar speakers have a relatively narrow frequency range and cannot be used for full-band music signals. On the other hand, the inherent distortion design of the guitar speakers for electric guitar signals will cause serious distortion of music signals. On the other hand, music amplifiers (such as sound box devices) are not suitable for amplifying electric guitar signals because they cannot produce the guitar timbre with unique distortion effects familiar to musicians and listeners. Therefore, when playing an electric guitar in scenarios such as concerts, separate guitar amplifier and music amplifier are often required to amplify the guitar sound and other accompaniment music respectively, and it is difficult to add other accompaniment music to the guitar sound, which limits the usage scenarios of the guitar amplifier and increases the complexity of audio processing. In this regard, one consideration is to replace the guitar speaker of the guitar amplifier with a conventional music speaker, but this will cause the output guitar sound to lose the unique distortion effect of the guitar speaker, which is difficult for musicians, listeners, etc. to accept. Although the effects unit in the guitar amplifier can also add some distortion effect to the audio signal, as mentioned above, the causes of speaker distortion are more complicated and cannot be simply compensated by effects unit distortion.

In view of the above problems, the present disclosure provides an audio processing method and an audio processing device, which can use a conventional music speaker to produce a guitar timbre with a distortion effect, and can also amplify the music signal.

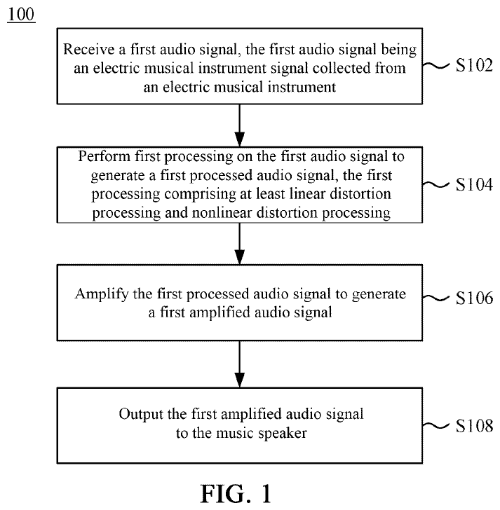

The audio processing device according to one or more embodiments of the present disclosure will be described below with reference to FIG. 1. FIG. 1 illustrates a flowchart 100 of an audio processing method according to one or more embodiments of the present disclosure. The audio processing method according to one or more embodiments of the present disclosure may be performed by, for example, an audio processing device, a computing device with audio processing capabilities, or the like, and the embodiments of the present disclosure do not impose any specific limitations in this regard.

As shown in FIG. 1, in step S102, a first audio signal is received, where the first audio signal is an electric musical instrument signal collected from an electric musical instrument, that is, an electric signal collected by a collection device such as a pickup when the electric musical instrument is played. Generally, the electric musical instrument may be configured with a pickup that is capable of converting vibration signals of strings or keys into electric signals. For example, a pickup consisting of a magnet and a coil can generate an electric current signal when a string or key vibrates based on the principles of electromagnetism. In one or more embodiments of the present disclosure, the first audio signal may be, for example, an electric guitar signal collected by the pickup when the electric guitar is played.

In step S104, first processing can be performed on the first audio signal to generate a first processed audio signal, where the first processing may include at least linear distortion processing and nonlinear distortion processing.

In one or more embodiments of the present disclosure, the linear distortion processing refers to or may include changing the amplitude or phase of frequency components in the first audio signal, which does not introduce new frequency components into the audio signal and generally does not change the waveform of the audio signal at various frequencies, but rather changes the amplitude or phase of certain frequency components. Thus, the linear distortion processing may include amplitude distortion processing that changes the amplitude of the frequency components of the audio signal and phase distortion processing that changes the phase of the frequency components of the audio signal.

In one or more embodiments of the present disclosure, the nonlinear distortion processing refers to or may include adding a new frequency component to the first audio signal, for example, adding a high-order harmonic having a frequency that is an integer multiple of the fundamental frequency. Nonlinear distortion processing changes the waveform of the audio signal and generates a new harmonic component in the audio signal, so it can also be called waveform distortion. For audio processing, nonlinear distortion may include, for example, harmonic distortion, clipping distortion, intermodulation distortion, transient distortion, and the like.

In this step, linear distortion processing and nonlinear distortion processing can be performed on the first audio signal respectively to generate a linear distortion result and a nonlinear distortion result respectively. Thereafter, a first processed audio signal is generated based on at least the linear distortion result, the nonlinear distortion result, and the first audio signal. For example, the linear distortion result, the nonlinear distortion result, and the first audio signal can be weighted to generate a weighted signal, and a first processed audio signal is generated based the weighted signal.

Through the linear distortion processing and nonlinear distortion processing described above, a distortion effect can be introduced into the first audio signal such as an electric guitar signal to, for example, produce a guitar timbre with a unique distortion effect that is appreciated by musicians or listeners.

In addition, according to one or more embodiments of the present disclosure, the first processing of the first audio signal may also include first equalization processing, which may include filtering and gain adjustment of the weighted signal to make the generated first processed audio signal within a predetermined frequency range and have a predetermined frequency response curve. Specifically, the first processed audio signal can be limited to a frequency range for an electric musical instrument, such as a frequency range from about 60 Hz to 5 kHz for an electric guitar, by the filtering in the first equalization processing. The filtering may be performed by, for example, a low-pass filter and a high-pass filter, or by a band-pass filter within a specified frequency range, and the embodiments of the present disclosure do not impose any specific limitation in this regard. In addition, through the gain adjustment in the first equalization processing, the gains of different frequency components of the audio signal can be changed, thereby achieving a predetermined frequency response curve. The gain adjustment may be performed by, for example, a low-cut filter, a high-cut filter, a peak filter, a notch filter, etc. or a combination thereof, and the embodiments of the present disclosure do not impose any specific limitation in this regard. In one or more embodiments of the present disclosure, the first equalization processing may be implemented by, for example, an equalizer (EQ), and the embodiments of the present disclosure do not impose any specific limitation in this regard.

The linear distortion processing, nonlinear distortion processing, and first equalization processing included in the first processing described above can be implemented in the same digital signal processing (DSP) module, but the embodiments of the present disclosure do not impose any specific limitation in this regard, and the various processing described above can alternatively be implemented separately in different DSP modules.

In addition, according to one or more embodiments of the present disclosure, the first processing of the first audio signal may also include effect processing, which can change one or more of the waveform, wavelength, phase, amplitude, and frequency component of the first audio signal to generate electronic sound effects such as distortion, echo, reverberation, chorus, vibrato, etc. The effect processing can be implemented by, for example, an effects unit, which can be located before, in, or after the DSP module used for implementing the linear distortion processing, nonlinear distortion processing, and first equalization processing. The embodiments of the present disclosure do not impose any specific limitation in this regard.

After the first processed audio signal is generated, in step S106, the first processed audio signal can be amplified to generate a first amplified audio signal. In one or more embodiments of the present disclosure, the amplifier used for amplifying the first amplified audio signal may include, for example, a preamplifier and a power amplifier, where the preamplifier pre-amplifies the low-intensity audio signal and can appropriately adjust the timbre and noise level of the audio signal, and the power amplifier significantly increases the power of the audio signal to drive a subsequent speaker to produce sound effects.

In step S108, the first amplified audio signal generated by amplifying the first processed audio signal is output to a music speaker for playback. The music speaker here may be a conventional speaker suitable for music playback, or more specifically, may be a full-range speaker capable of covering the frequency range perceived by the human ear (approximately 20 Hz to 20 kHz), rather than a guitar speaker having a linear or nonlinear distortion component and a narrow frequency range.

The audio processing method according to one or more embodiments of the present disclosure may be implemented by, for example, an amplifier for an electric musical instrument, and in particular, may be implemented by an electric guitar amplifier or an electric bass amplifier. Taking an electric guitar amplifier as an example, using the audio processing method of the present disclosure, a conventional music speaker can be used to produce a guitar sound with a unique distortion effect without the need for a guitar speaker with a narrow frequency range and including a linear or nonlinear distortion component. This is because the electric guitar signal is subjected to the linear distortion processing and nonlinear distortion processing as described in the above step S104 in the DSP module, thereby producing the desired unique distortion effect.

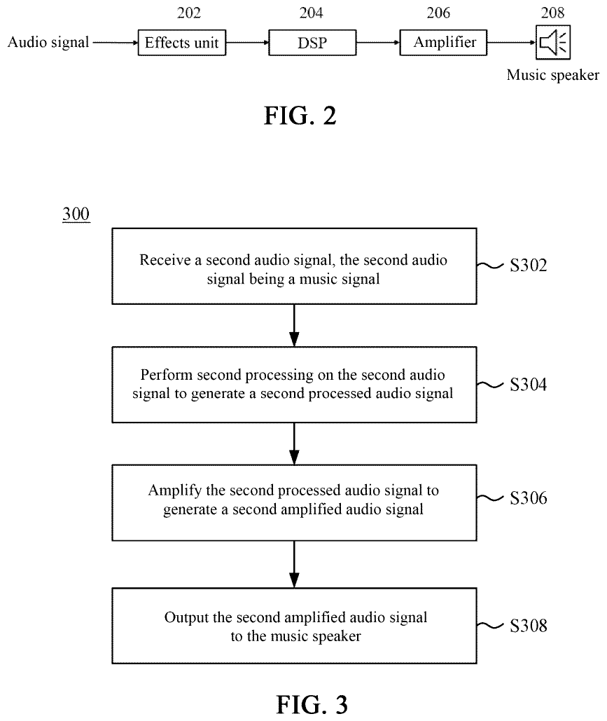

FIG. 2 illustrates a flowchart of an audio processing method according to one or more embodiments of the present disclosure. In this example, an effects unit 202, a DSP module 204, an amplifier 206, and a music speaker 208 are schematically shown. It should be noted that the modules and arrangement order thereof shown in FIG. 2 are merely examples and not limitations. For example, the DSP module 204 may be integrated with the effects unit 202 or the amplifier 206, or the effects unit 202 may be placed after the DSP module 204, and so forth.

As shown in FIG. 2, upon receiving an input audio signal such as an electric guitar signal, the effects unit 202 can add electronic sound effects such as distortion, echo, reverberation, chorus, vibrato, etc. to the input audio signal. Thereafter, the DSP module 204 can perform the linear distortion processing, nonlinear distortion processing, and first equalization processing described above on the audio signal from the effects unit 202 to generate a processed audio signal. The processed audio signal is amplified by the amplifier 206 and then output to the music speaker 208 for playback. It can be seen that, by utilizing the audio processing method of the present disclosure, it is possible to amplify an electric guitar signal using a conventional music amplifier to produce a guitar sound with a unique distortion effect.

In addition, the audio processing method according to one or more embodiments of the present disclosure can also be used for amplifying music signals. FIG. 3 illustrates another flowchart 300 of an audio processing method according to one or more embodiments of the present disclosure, including steps S302 to S308. Steps S302 to S308 may be performed before or after steps S102 to S108, or may be performed in parallel with steps S102 to S108 (e.g., in the case of a plurality of processing modules and a plurality of speakers), and the embodiments of the present disclosure do not impose any specific limitation in this regard.

In step S302, a second audio signal is received. The second audio signal may be a music signal, such as accompaniment music, singing music, an audio signal collected from nature, or any other audio signal than electric musical instrument signals collected from electric musical instruments. The embodiments of the present disclosure do not impose any specific limitation in this regard.

In step S304, second processing is performed on the second audio signal to generate a second processed audio signal. The second processing may include second equalization processing, which may, for example, perform gain adjustment on the second audio signal to change the gain of different frequency components of the audio signal, thereby achieving a predetermined frequency response curve. Similar to the first equalization processing, the gain adjustment in the second equalization processing may be performed by, for example, a low-cut filter, a high-cut filter, a peak filter, a notch filter, etc. or a combination thereof, and the embodiments of the present disclosure do not impose any specific limitation in this regard. In one or more embodiments of the present disclosure, the second equalization processing may be implemented by, for example, an equalizer (EQ), and the embodiments of the present disclosure do not impose any specific limitation in this regard. The second processing in step S304 may be performed, for example, in a DSP module, and the DSP module used for the second processing may be the same as or different from the DSP module used for the first processing in step S104, and the embodiments of the present disclosure do not impose any specific limitation in this regard.

In step S306, the second processed audio signal is amplified to generate a second amplified audio signal. For example, the second processed audio signal can be amplified via a preamplifier and a power amplifier, respectively. Next, in step S308, the second amplified audio signal is output to a music speaker for playback.

By using the audio processing method according to one or more embodiments of the present disclosure, a musical instrument amplification mode and a music amplification mode can be provided simultaneously in the same audio processing device (e.g., a guitar amplifier). In the musical instrument amplification mode, steps S102 to S108 can be used to amplify the electric musical instrument signal; and in the music amplification mode, steps S302 to S308 can be used to amplify the music signal. This overcomes the technical defects in the prior art that guitar amplifiers cannot amplify music signals and conventional music amplifiers cannot satisfactorily amplify electric guitar signals, and realizes a variety of audio processing functions that can amplify both electric musical instrument signals such as electric guitar signals and music signals.

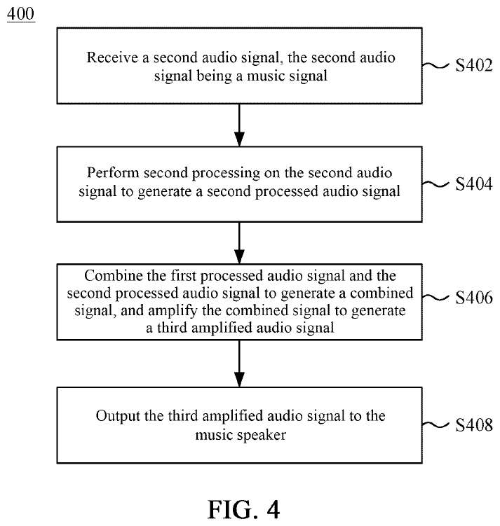

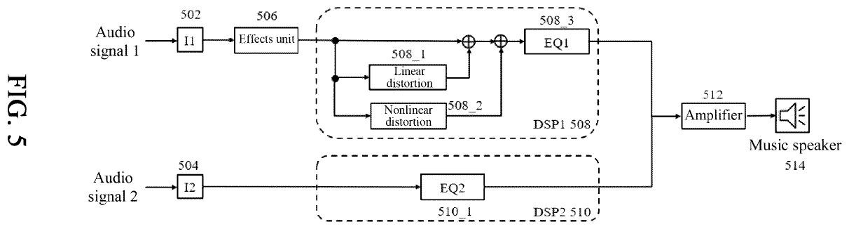

In addition, the audio processing method according to one or more embodiments of the present disclosure can also be used for providing a hybrid amplification mode, in which an electric musical instrument signal and a music signal can be received simultaneously, and the two are respectively processed accordingly, and the processed signals are combined and amplified and output to a music speaker. Refer to FIG. 4, which illustrates another flowchart 400 of an audio processing method according to one or more embodiments of the present disclosure, where in addition to steps S102 to S104 shown in FIG. 1, the audio processing method may further include steps S402 to S408. Furthermore, steps S402 to S404 may be executed before, after, or in parallel with steps S102 to S104. The embodiments of the present disclosure do not impose any specific limitation in this regard. In addition, steps S402 to S404 are similar to steps S302 to S304, and duplicated description of the same contents is omitted here for the sake of brevity.

In step S406, the first processed audio signal and the second processed audio signal can be combined to generate a combined signal. Such combination may be a simple superposition or a weighted combination, etc. The embodiments of the present disclosure do not impose any specific limitation in this regard. The first processed audio signal may be obtained, for example, by using steps S102 to S104 as described above, which will not be detailed again here. Thereafter, the combined signal is amplified to generate a third amplified audio signal, and the third amplified audio signal is output to the music speaker for playback in step S408.

By using the audio processing method according to one or more embodiments of the present disclosure, a musical instrument amplification mode, a music amplification mode, and a hybrid amplification mode can be provided simultaneously in the same audio processing device (e.g., a guitar amplifier). In the hybrid amplification mode, an electric musical instrument signal such as an electric guitar signal and a music signal can be received simultaneously, and the two can be respectively processed accordingly. For example, the electric musical instrument signal can be subjected to first processing including effect processing, linear distortion processing, nonlinear distortion processing, and first equalization processing, and the music signal can be subjected to second processing including second equalization processing. The processed electric musical instrument signal and music signal are combined and amplified and then output to the music speaker for playback. In this way, in the hybrid amplification mode, it is possible to add other music such as accompaniment to the musical instrument sound when playing an electric musical instrument, thereby providing richer music experience.

FIG. 5 illustrates a flowchart of an audio processing method of another example according to one or more embodiments of the present disclosure. In this example, a first audio interface (referred to simply as I1) 502, a second audio interface (referred to simply as 12) 504, an effects unit 506, a first DSP module (referred to simply as DSP1) 508, a second DSP module (referred to simply as DSP2) 510, an amplifier 512, and a music speaker 514 are schematically illustrated. It should be noted that the various modules and arrangement order thereof shown in FIG. 5 are merely examples and not limitations. For example, the first DSP module 508 may also be integrated with the effects unit 506, or the effects unit 506 may be placed after the first DSP module 508, or the first DSP module 508 and the second DSP module 510 may be combined into a single DSP module, and so forth.

According to one or more examples of the present disclosure, in the musical instrument amplification mode, the first audio interface 502 can receive a first audio signal (shown as audio signal 1 in FIG. 5), which may be an electric musical instrument signal collected from an electric musical instrument, such as an electric guitar signal collected by a pickup when an electric guitar is played. The first audio signal is input to the first DSP module 508 after the electronic sound effect is added thereto by the effects unit 506. In the example of FIG. 5, the first DSP module 508 may further include a linear distortion module 508_1, a nonlinear distortion module 508_2, and a first equalization module (referred to simply as EQ1) 508_3, which are used respectively for performing linear distortion processing, nonlinear distortion processing, and first equalization processing as described above with reference to FIG. 1 on the first audio signal from the effects unit 506 to generate a first processed audio signal. The first processed audio signal is amplified by the amplifier 512 to generate a first amplified audio signal which is output to the music speaker 514.

According to one or more examples of the present disclosure, in the music amplification mode, the second audio interface 504 can receive a second audio signal (shown as audio signal 2 in FIG. 5), which may be a music signal, such as accompaniment music, singing music, an audio signal collected from nature, etc., or any other audio signal than electric musical instrument signals collected from electric musical instruments. The second DSP module 510 may include, for example, a second equalization module (referred to simply as EQ2) 510_1, and the second audio signal undergoes second equalization processing in EQ2 to generate a second processed audio signal. The second processed audio signal is amplified by the amplifier 512 to generate a second amplified audio signal which is output to the music speaker 514.

According to one or more examples of the present disclosure, in the hybrid amplification mode, the first audio interface 502 can receive a first audio signal such as an electric guitar signal, while the second audio interface 504 can receive a second audio signal as a music signal. After the first audio signal and the second audio signal are respectively processed similarly to the above example, a first processed audio signal and a second processed audio signal are generated. The first processed audio signal and the second processed audio signal are combined together and amplified by the amplifier 512 to generate a third amplified audio signal which is output to the music speaker 514.

An audio processing method according to one or more embodiments of the present disclosure is described above with reference to FIGS. 1 to 5 and can use a conventional music speaker to produce a guitar sound with a unique distortion effect without the need for a guitar speaker with a narrow frequency range and including a linear or nonlinear distortion component. In addition, the audio processing method according to one or more embodiments of the present disclosure can simultaneously provide a musical instrument amplification mode, a music amplification mode, and a hybrid amplification mode in the same audio processing device (e.g., a guitar amplifier), which overcomes the technical defects in the prior art that guitar amplifiers cannot amplify music signals and that conventional music amplifiers cannot satisfactorily amplify electric guitar signals, and realizes a plurality of audio processing functions that can amplify both electric musical instrument signals such as electric guitar signals and music signals, and can add accompaniment music to the musical instrument sound when playing electric musical instruments, thereby greatly improving the user experience and reducing the complexity of audio processing.

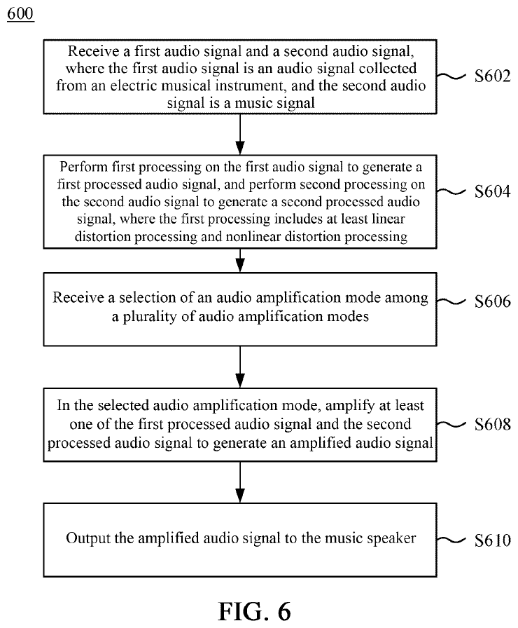

FIG. 6 illustrates another flowchart 600 of an audio processing method according to one or more embodiments of the present disclosure. Some of the details of the steps of the audio processing method shown in FIG. 6 are similar to those of the audio processing method described with reference to FIGS. 1 to 5, so duplicated description of some contents is omitted here for the sake of brevity.

As shown in FIG. 6, in step S602, a first audio signal and a second audio signal are received, where the first audio signal is an audio signal collected from an electric musical instrument, for example, it may be an electric guitar signal collected by a pickup when the electric guitar is played; and the second audio signal may be a music signal, such as accompaniment music, singing music, an audio signal collected from nature, or any other audio signal than electric musical instrument signals collected from electric musical instruments. The embodiments of the present disclosure do not impose any specific limitation in this regard.

In step S604, first processing is performed on the first audio signal to generate a first processed audio signal, and second processing is performed on the second audio signal to generate a second processed audio signal, where the first processing includes at least linear distortion processing and nonlinear distortion processing. Here, the first processing and the linear distortion processing and nonlinear distortion processing included therein are similar to those described above with reference to step S104, and the second processing is similar to that described above with reference to step S304, and detailed description thereof will not be made again here.

In step S606, a selection of an audio amplification mode among a plurality of audio amplification modes is received. In the audio processing method according to one or more embodiments of the present disclosure, a variety of audio amplification modes may be provided, including a musical instrument amplification mode, a music amplification mode, a hybrid amplification mode, etc., as described above with reference to FIGS. 1 to 5. The user can select any one of the plurality of audio amplification modes according to needs.

In step S608, in the selected audio amplification mode, at least one of the first processed audio signal and the second processed audio signal is amplified to generate an amplified audio signal. Specifically, when the selected audio amplification mode is the musical instrument amplification mode, the first processed audio signal can be amplified to generate an amplified audio signal; when the selected audio amplification mode is the music amplification mode, the second processed audio signal can be amplified to generate an amplified audio signal; and when the selected audio amplification mode is the hybrid amplification mode, the first processed audio signal and the second processed audio signal can be combined to generate a combined signal, and the combined signal is amplified to generate an amplified audio signal.

Thereafter, in step S610, the amplified audio signal can be output to a music speaker for playback, where the music speaker may be, for example, a full-range speaker capable of covering a frequency range perceived by the human ear. The audio processing method according to one or more embodiments of the present disclosure can simultaneously provide a variety of audio amplification modes including a musical instrument amplification mode, a music amplification mode, a hybrid amplification mode, etc., for user selection in the same audio processing device (e.g., a guitar amplifier), thereby realizing a variety of audio processing functions that can amplify electric musical instrument signals such as electric guitar signals and music signals, and add accompaniment music to the musical instrument sounds when playing electric musical instruments.

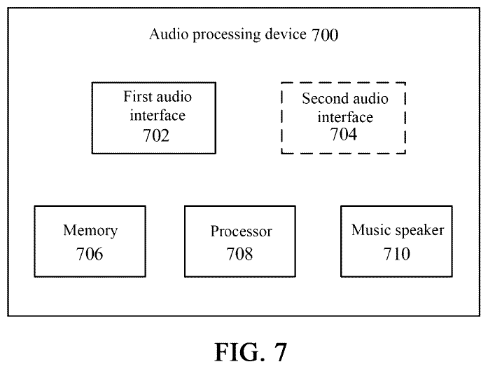

An audio processing device according to one or more embodiments of the present disclosure will be described below with reference to FIG. 7. FIG. 7 illustrates a schematic structural view of an audio processing device 700 according to one or more embodiments of the present disclosure. As shown in FIG. 7, the audio processing device 700 may include a first audio interface 702, a memory 706, at least one processor 708, and a music speaker 710. Optionally, the audio processing device 700 may further include a second audio interface 704. In addition to these components, the audio processing device 700 may also include other appropriate components, and detailed description of contents thereof is omitted here for the sake of brevity. In addition, since the functions of the components of the audio processing device 700 are similar to the details of the steps of the audio processing method described above with reference to FIGS. 1 to 6, duplicated description of some contents is omitted here for the sake of brevity. The audio processing device 700 according to one or more embodiments of the present disclosure may be, for example, an electric musical instrument amplifier or an electric musical instrument sound box, such as an electric guitar amplifier, an electric bass amplifier, etc. The embodiments of the present disclosure do not impose specific limitations in this regard.

The first audio interface 702 can receive a first audio signal which may be an electric musical instrument signal collected from an electric musical instrument, such as an electric guitar signal collected by a pickup when an electric guitar is played. The embodiments of the present disclosure do not impose any specific limitation in this regard.

Optionally, the second audio interface 704 can receive a second audio signal which may be a music signal, such as accompaniment music, singing music, an audio signal collected from nature, or any other audio signal than electric musical instrument signals collected from electric musical instruments. The embodiments of the present disclosure do not impose any specific limitation in this regard.

The memory 706 can store computer-readable instructions, and the at least one processor 708 is configured to execute the computer-readable instructions to perform the steps of the audio processing method described above with reference to FIGS. 1 to 6. Specifically, the audio processing device 700 can provide a variety of audio amplification modes including a musical instrument amplification mode, a music amplification mode, a hybrid amplification mode, etc., for user selection. According to one or more examples of the present disclosure, in the musical instrument amplification mode, the at least one processor 708 is configured to execute the computer-readable instructions to perform first processing including at least linear distortion processing and nonlinear distortion processing on a first audio signal to generate a first processed audio signal, and amplify the first processed audio signal to generate a first amplified audio signal. According to one or more examples of the present disclosure, in the music amplification mode, the at least one processor 708 is configured to execute the computer-readable instructions to perform second processing on a second audio signal to generate a second processed audio signal, and amplify the second processed audio signal to generate a second amplified audio signal; and according to one or more examples of the present disclosure, in the hybrid amplification mode, the at least one processor 708 is configured to execute the computer-readable instructions to combine the first processed audio signal and the second processed audio signal to generate a combined signal, and amplify the combined signal to generate a third amplified audio signal.

The music speaker 710 may be a conventional speaker suitable for playing music, or more specifically, may be a full-range speaker capable of covering the frequency range perceived by the human ear (approximately 20 Hz to 20 kHz), rather than a guitar speaker having a linear or nonlinear distortion component and a narrow frequency range. The music speaker 710 may be configured to output the first amplified audio signal, the second amplified audio signal, or the third amplified audio signal accordingly based on the selected audio amplification mode. As an example and not a limitation, in the musical instrument amplification mode, an amplified electric guitar sound can be output; in the music amplification mode, amplified music can be output; and in the hybrid amplification mode, an amplified electric guitar sound with added musical accompaniment can be output.

The embodiments of the present disclosure may also be implemented as a computer-readable storage medium. The computer-readable storage medium according to the embodiments of the present disclosure has computer-readable instructions stored thereon. The computer-readable instructions, when executed by a processor, can perform the audio processing method according to various embodiments of the present disclosure described with reference to the drawings above. The computer-readable storage medium includes, but is not limited to, for example, a volatile memory and/or nonvolatile memory. The volatile memory may include, for example, a random access memory (RAM) and/or a cache memory (cache), and the like. The non-volatile memory may include, for example, a read-only memory (ROM), a hard disk, a flash memory, and the like.

According to an embodiment of the present disclosure, a computer program product or a computer program is further provided. The computer program product or the computer program includes computer-readable instructions, and the computer-readable instructions are stored in a computer-readable storage medium. A processor of a computer device can read the computer-readable instructions from the computer-readable storage medium, and the processor executes the computer-readable instructions to cause the computer device to perform the audio processing method described in the above embodiments.

The program portion of the technology may be considered as a “product” or “artifact” existing in the form of executable codes and/or associated data, which is engaged or implemented through a computer-readable medium. A tangible, permanent storage medium may include the memory or storage used in any computer, processor, or similar device or related module. For example, various semiconductor memories, tape drives, disk drives, or any similar devices capable of providing storage functions for software.

All of the software or portions thereof may from time to time communicate over a network, such as the Internet or other communications networks. Such communication may load software from one computer device or processor to another. For example, loading from one server or host of the device to one hardware platform of a computing environment, or another computing environment implementing the system, or a system of similar functionality related to providing required information. Therefore, another medium capable of transferring software elements may also be used as a physical connection between local devices, such as light wave, radio wave, electromagnetic wave, etc., which are propagated through cables, optical cables, or air. The physical medium used to carry waves, such as cables, wireless links, optical cables, and the like devices, may also be considered a medium for carrying the software. As used herein, unless restricted to tangible “storage” media, other terms referring to computer or machine “readable media” refer to media that participate in the process of a processor executing any instructions.

The present application uses specific words to describe embodiments of the present application. For example, “first/second embodiment,” “an embodiment”, and/or “some embodiments” means a feature, structure, or characteristic associated with at least one embodiment of the present application. Accordingly, it should be emphasized and noted that “an embodiment” or “one embodiment” or “an alternative embodiment” referred to two or more times in different places in this specification does not necessarily refer to the same embodiment. In addition, certain features, structures, or characteristics of one or more embodiments of the present application may be combined as appropriate.

In addition, it can be understood by those skilled in the art that aspects of the present application may be illustrated and described by a number of patentable categories or circumstances, including any new and useful process, machine, product, or combination of substances, or any new and useful improvement thereof. Accordingly, aspects of the present application may be performed entirely by hardware, may be performed entirely by software (including firmware, resident software, microcode, or the like), or may be performed by a combination of hardware and software. All of the above hardware or software may be referred to as “data blocks”, “modules”, “engines”, “units”, “components” or “systems”. Additionally, aspects of the present application may be manifested as a computer product disposed in one or more computer-readable media, the product including computer-readable program code.

Unless otherwise defined, all terms used herein, including technical and scientific terms, have the same meaning as commonly understood by those of ordinary skill in the art to which the present invention belongs. It should also be understood that terms such as those defined in common dictionaries should be construed as having a meaning consistent with their meaning in the context of the relevant technology and should not be construed with idealized or extremely formalized meanings unless expressly defined as such herein.

The foregoing is a description of the present invention and should not be considered a limitation thereof. Although several exemplary embodiments of the present invention are described, it will be readily understood by those skilled in the art that many modifications can be made to the exemplary embodiments without departing from the novel teachings and advantages of the present invention. Accordingly, all such modifications are intended to be encompassed within the scope of the present invention as defined by the claims. It should be understood that the foregoing is a description of the present invention and should not be considered to be limited to the particular embodiments as disclosed, and that modifications to the disclosed embodiments, as well as other embodiments, are intended to be included within the scope of the appended claims. The present invention is defined by the claims and equivalents thereof.

1. An audio processing method, comprising:
receiving a first audio signal, the first audio signal being an electric musical instrument signal collected from an electric musical instrument;
performing first processing on the first audio signal to generate a first processed audio signal, the first processing comprising at least linear distortion processing and nonlinear distortion processing;
amplifying the first processed audio signal to generate a first amplified audio signal; and
outputting the first amplified audio signal to a music speaker.

2. The method of claim 1, wherein the linear distortion processing comprises changing an amplitude or phase of a frequency component of the first audio signal to generate a linear distortion result, and the nonlinear distortion processing comprises adding a new frequency component to the first audio signal to generate a nonlinear distortion result; and
wherein performing the first processing on the first audio signal to generate the first processed audio signal comprises:
generating the first processed audio signal based at least on the linear distortion result, the nonlinear distortion result, and the first audio signal.

3. The method of claim 2, wherein generating the first processed audio signal based at least on the linear distortion result, the nonlinear distortion result, and the first audio signal comprises:
weighting the linear distortion result, the nonlinear distortion result, and the first audio signal to generate a weighted signal, and generating the first processed audio signal based on the weighted signal.

4. The method of claim 3, wherein the first processing further comprises first equalization processing that includes filtering and gain adjustment of the weighted signal to make the first processed audio signal within a predetermined frequency range and have a predetermined frequency response curve.

5. The method of claim 1, wherein the first processing further comprises effect processing that changes at least one of waveform, wavelength, phase, amplitude, and frequency component of the first audio signal.

6. The method of claim 1, wherein the electric musical instrument is an electric guitar or an electric bass, and the music speaker is a full-frequency speaker covering a frequency range perceivable by a human ear.

7. The method of claim 1, further comprising:
receiving a second audio signal, the second audio signal being a music signal;
performing second processing on the second audio signal to generate a second processed audio signal;
amplifying the second processed audio signal to generate a second amplified audio signal; and
outputting the second amplified audio signal to the music speaker.

8. The method of claim 7, wherein the music signal is an audio signal other than an electric musical instrument signal collected from an electric musical instrument.

9. The method of claim 1, further comprising:
receiving a second audio signal, the second audio signal being a music signal;
performing second processing on the second audio signal to generate a second processed audio signal;
combining the first processed audio signal and the second processed audio signal to generate a combined signal, and amplifying the combined signal to generate a third amplified audio signal; and
outputting the third amplified audio signal to the music speaker.

10. The method of claim 9, wherein the music signal is an audio signal other than an electric musical instrument signal collected from an electric musical instrument.

11. An audio processing device, comprising:
a first audio interface configured to receive a first audio signal, the first audio signal being an electric musical instrument signal collected from an electric musical instrument;
a memory having computer-readable instructions store therein;
at least one processor configured to execute the computer-readable instructions to generate a first amplified audio signal, the computer readable instructions comprise:
receiving a first audio signal, the first audio signal being an electric musical instrument signal collected from an electric musical instrument;
performing first processing on the first audio signal to generate a first processed audio signal, the first processing comprising at least linear distortion processing and nonlinear distortion processing;
amplifying the first processed audio signal to generate a first amplified audio signal; and
outputting the first amplified audio signal to a music speaker; and
a music speaker configured to output the first amplified audio signal.

12. The device of claim 11, wherein the computer readable instructions further comprise:
changing an amplitude or phase of a frequency component of the first audio signal to generate a linear distortion result;
adding a new frequency component to the first audio signal to generate a nonlinear distortion result; and
performing the first processing on the first audio signal to generate the first processed audio signal by generating the first processed audio signal based at least on the linear distortion result, the nonlinear distortion result, and the first audio signal.

13. The device of claim 12, wherein the computer readable instruction of generating the first processed audio signal based at least on the linear distortion result, the nonlinear distortion result, and the first audio signal further comprises:
weighting the linear distortion result, the nonlinear distortion result, and the first audio signal to generate a weighted signal, and generating the first processed audio signal based on the weighted signal.

14. The device of claim 13, wherein the computer readable instruction of performing first processing further comprises first equalization processing that includes filtering and gain adjustment of the weighted signal to make the first processed audio signal within a predetermined frequency range and have a predetermined frequency response curve.

15. The device of claim 11, wherein the computer readable instruction of performing first processing further comprises effect processing that changes at least one of waveform, wavelength, phase, amplitude, and frequency component of the first audio signal.

16. The device of claim 11, wherein the electric musical instrument is an electric guitar or an electric bass, and the music speaker is a full-frequency speaker covering a frequency range perceivable by a human ear.

17. The device of claim 11, further comprising a second audio interface configured to receive a second audio signal, the second audio signal being a music signal, wherein the at least one processor is further configured to execute the computer-readable instructions to:
perform second processing on the second audio signal to generate a second processed audio signal;
combine the first processed audio signal and the second processed audio signal to generate a combined signal, and amplify the combined signal to generate a third amplified audio signal; and
wherein the music speaker is further configured to output the third amplified audio signal.
